(19) United States
(12) Patent Application Publication
(10) Pub. No.: US 2021/0206616 A1
(43) Pub. Date: Jul. 8, 2021

(54) BAR GUN

(71) Applicants: Dustin Hartsfield, Sebastian, FL (US); John Newton, Vero Beach, FL (US); Michael Cheney, Vero Beach, FL (US); Peter Brooke, Micco, FL (US); Gillian Callaghan, Vero Beach, FL (US); Rory Pawl, West Bloomfield, MI (US); Jacob Lockwood, Vero Beach, FL (US)

(72) Inventors: Dustin Hartsfield, Sebastian, FL (US); John Newton, Vero Beach, FL (US); Michael Cheney, Vero Beach, FL (US); Peter Brooke, Micco, FL (US); Gillian Callaghan, Vero Beach, FL (US); Rory Pawl, West Bloomfield, MI (US); Jacob Lockwood, Vero Beach, FL (US)

(73) Assignee: GATE CFV SOLUTIONS, INC., Sebastian, FL (US)

(21) Appl. No.: 17/142,893

(22) Filed: Jan. 6, 2021

Related U.S. Application Data
(60) Provisional application No. 62/957,974, filed on Jan. 7, 2020.

(51) Int. Cl. B67D 1/00

(52) U.S. Cl. CPC B67D 1/0086; B67D 1/0006

(57) ABSTRACT

Examples disclosed herein relate to a cartridge including: a body with a first groove and a second groove, the body including a body inlet area and a body outlet area; an o-ring coupled to body via the first groove; a throttle pin coupled to the top retainer through the inlet area; a spring cap with a groove area; a spring cap o-ring coupled to the spring cap via the groove area; a spring coupled to a bottom retainer; a diaphragm coupled to the bottom retainer; and a top retainer coupled to the diaphragm.

### REFERENCE

The present application claims priority to U.S. provisional patent application Ser. No. 62/957,974, entitled “Bar Gun”, filed on Jan. 7, 2020, which is incorporated in its entirety herein by reference.

### FIELD

The subject matter disclosed herein relates to utilizing CF Valve functionality in a bar gun. More specifically, to a CF Valve functionality that allows for enhanced fluid control.

### INFORMATION

The dispensing industry has numerous ways to dispense one or more fluids and/or gases. This disclosure highlights enhanced devices, methods, and systems for dispensing these one or more fluids and/or gases.

### BRIEF DESCRIPTION OF THE FIGURES

Non-limiting and non-exhaustive examples will be described with reference to the following figures, wherein like reference numerals refer to like parts throughout the various figures.

FIG. 1A is an illustration of a CF Cartridge utilized in a bar gun, according to one embodiment.

FIG. 1B is another illustration of a CF Cartridge utilized in a bar gun, according to one embodiment.

FIG. 1C is another illustration of a CF Cartridge utilized in a bar gun, according to one embodiment.

FIG. 1D is another illustration of a CF Cartridge utilized in a bar gun, according to one embodiment.

FIG. 1E is another illustration of a CF Cartridge utilized in a bar gun, according to one embodiment.

FIG. 1F is an illustration of a CF Cartridge being placed into a chamber of a device, according to one embodiment.

FIG. 1G is an illustration of a manifold of a device, according to one embodiment.

FIG. 1H is another illustration of a CF Cartridge being placed into a chamber of a device, according to one embodiment.

FIG. 1I is an illustration of a CF Cartridge inside a chamber of a device, according to one embodiment.

FIG. 1J is an illustration of a device using the CF Cartridge, according to one embodiment.

FIG. 2A is an illustration of a CF Cartridge, according to one embodiment.

FIG. 2B is another illustration of a CF Cartridge, according to one embodiment.

FIG. 2C is another illustration of a CF Cartridge, according to one embodiment.

FIG. 2D is another illustration of a CF Cartridge, according to one embodiment.

FIG. 3A is an illustration of a pin and pinhead, according to one embodiment.

FIG. 3B is another illustration of a pin and pinhead, according to one embodiment.

FIG. 3C is another illustration of a pin and pinhead, according to one embodiment.

FIG. 4A is an illustration of a uniform inlet flow to body size device, according to one embodiment.

FIG. 4B is an illustration of a non-uniform inlet flow to body size device, according to one embodiment.

FIG. 4C is another illustration of a non-uniform inlet flow to body size device, according to one embodiment.

FIG. 4D is another illustration of a non-uniform inlet flow to body size device, according to one embodiment.

FIG. 4E is another illustration of a non-uniform inlet flow to body size device, according to one embodiment.

FIG. 5A is an illustration of a flow pattern into a CF Valve, according to one embodiment.

FIG. 5B is another illustration of a flow pattern into a CF Valve, according to one embodiment.

FIG. 5C is an illustration of various flow patterns into a CF Valve, according to various embodiments.

FIG. 6A is an illustration of a bar gun, according to one embodiment.

FIG. 6B is another illustration of a bar gun, according to one embodiment.

FIG. 7 is an illustration of CF Valve with an orifice, according to one embodiment.

FIG. 8 is another illustration of CF Valves with orifices, according to one embodiment.

FIG. 9 shows various illustrations of a bar gun, according to a couple of embodiments.

FIG. 10A is an illustration of CF Valve being placed into a bar gun application, according to one embodiment.

FIG. 10B is an illustration of CF Valve manifold utilized in a bar gun application, according to one embodiment.

FIG. 11A is an illustration of CF Valve in a bar gun application, according to one embodiment.

FIG. 11B is another illustration of CF Valve in a bar gun application, according to one embodiment.

FIG. 12 is an illustration of a CF Valve device, according to one embodiment.

FIG. 13 is an illustration of a CF Valve device in a bar gun application, according to one embodiment.

FIG. 14 is another illustration of a CF Valve device in a bar gun application, according to one embodiment.

FIG. 15 is another illustration of a CF Valve device in a bar gun application, according to one embodiment.

FIG. 16 is another illustration of a CF Valve device in a bar gun application, according to one embodiment.

FIG. 17 is another illustration of a CF Valve device in a bar gun application, according to one embodiment.

FIG. 18 is another illustration of a CF Valve device in a bar gun application, according to one embodiment.

### DETAILED DESCRIPTION OF THE DISCLOSURE

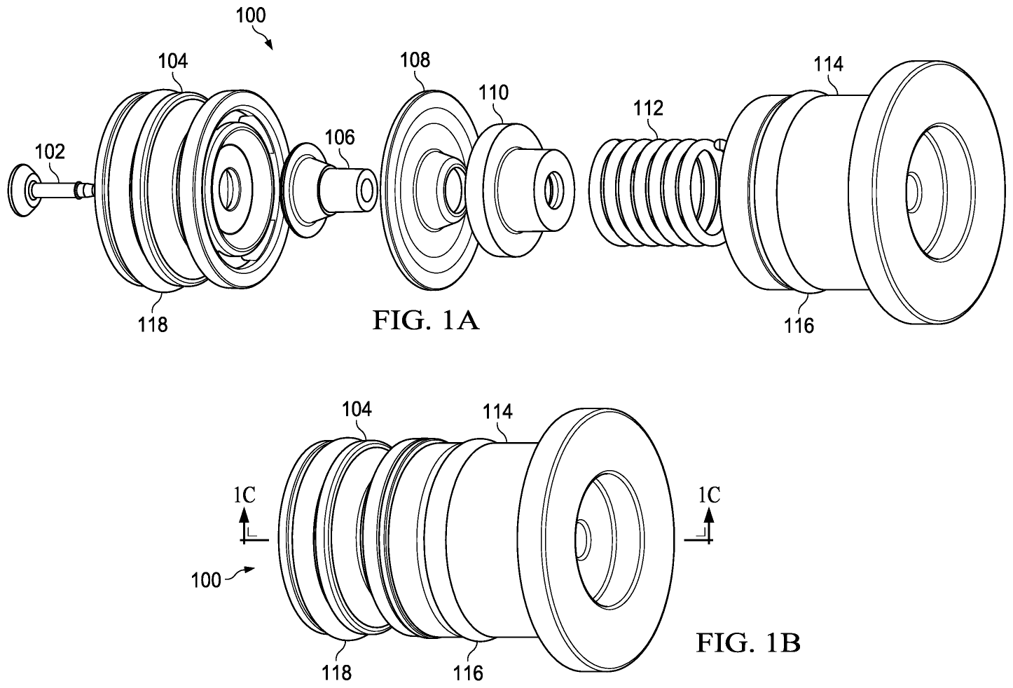

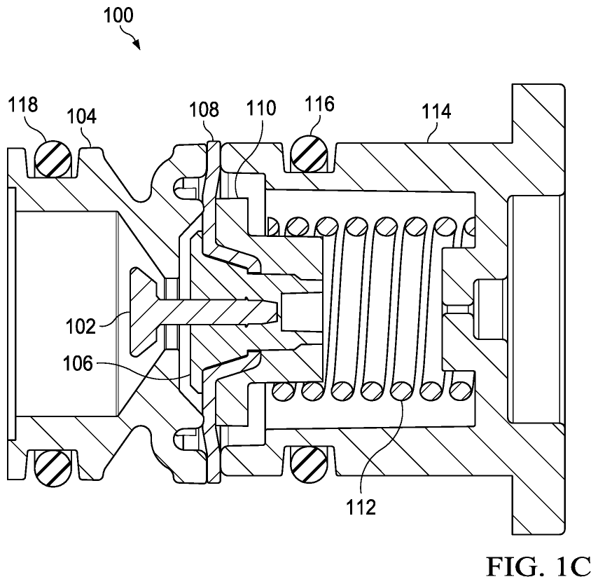

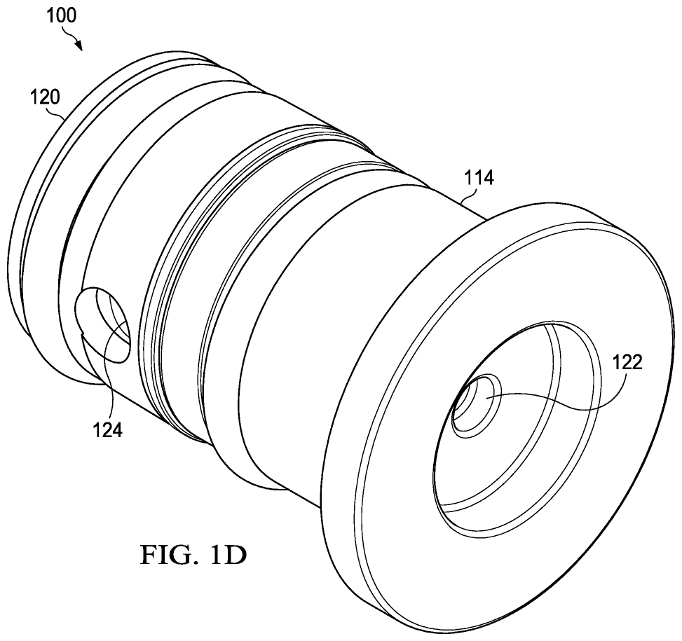

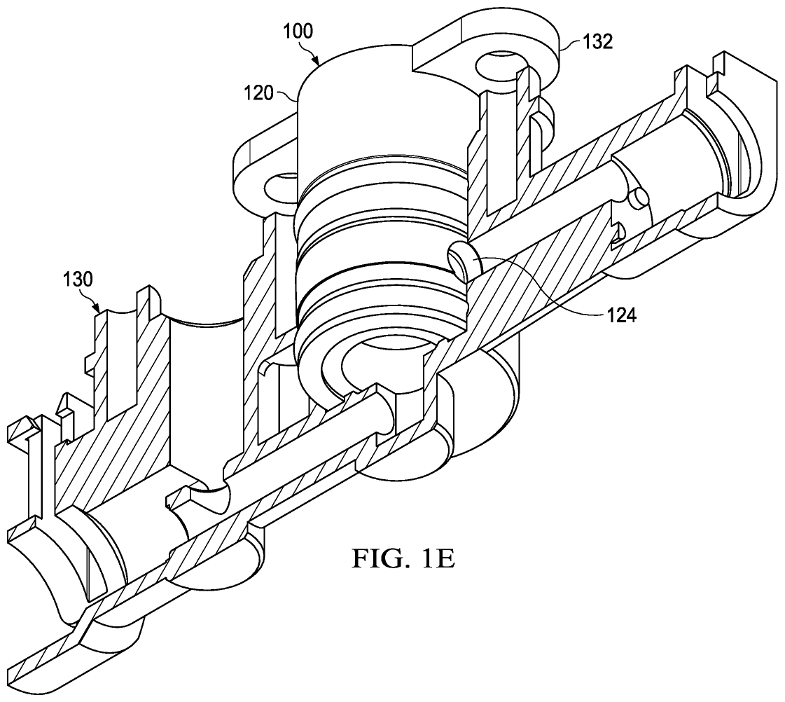

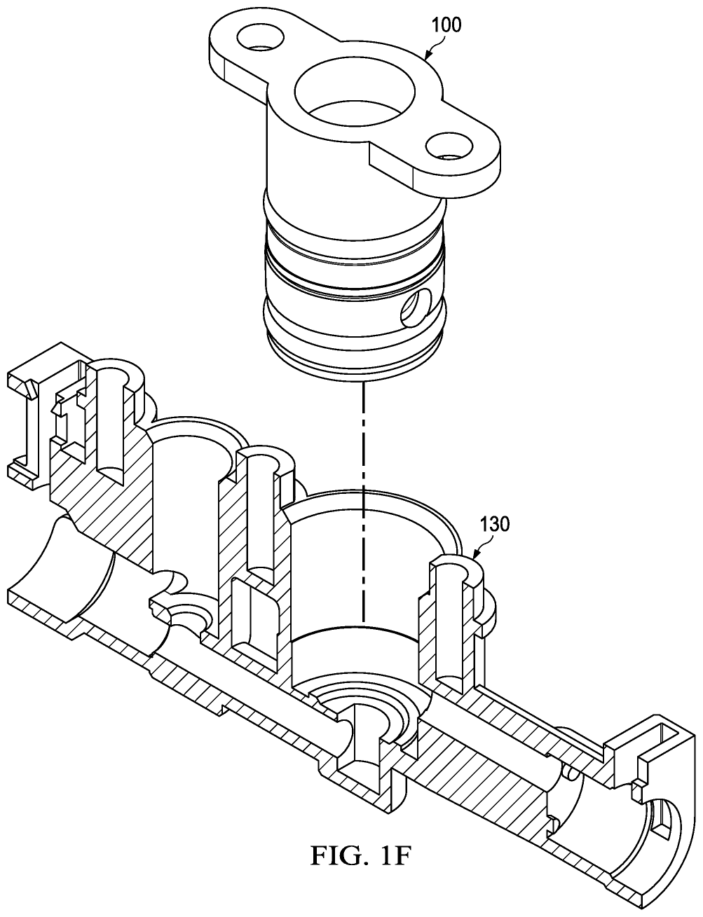

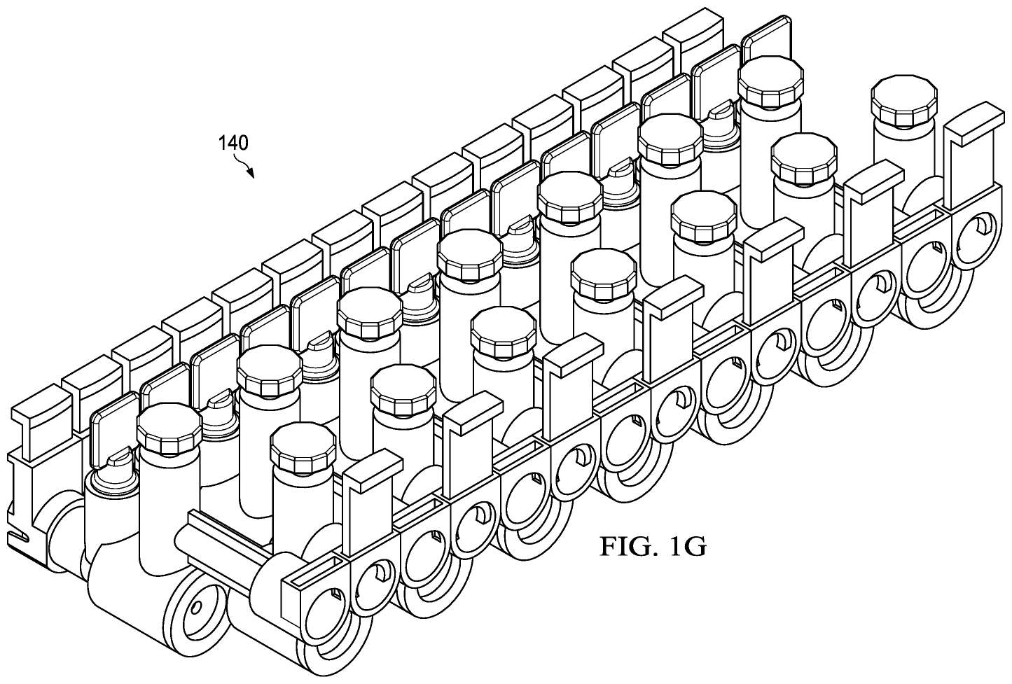

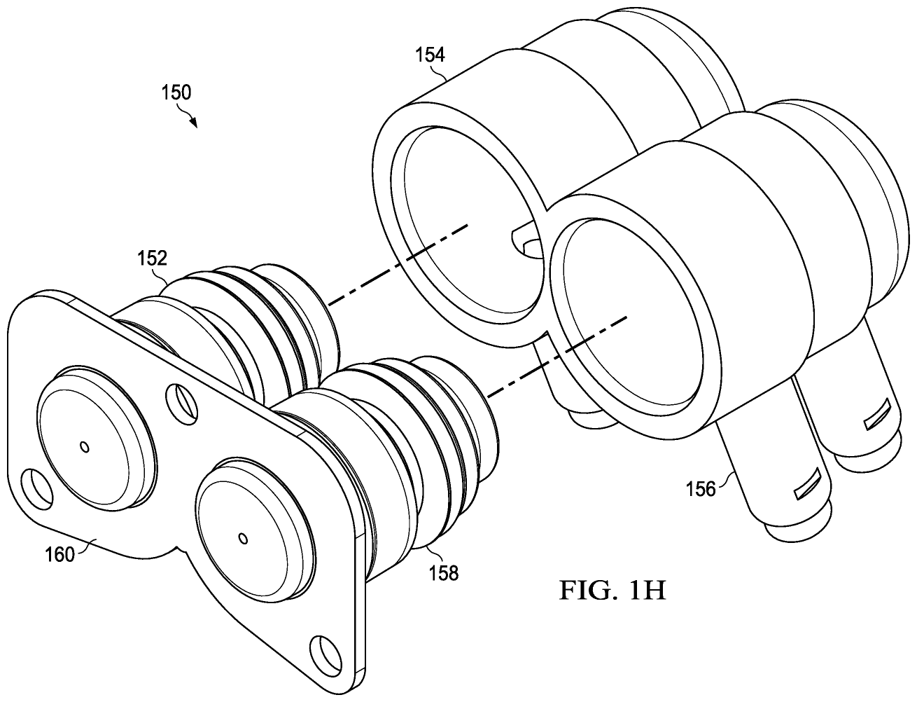

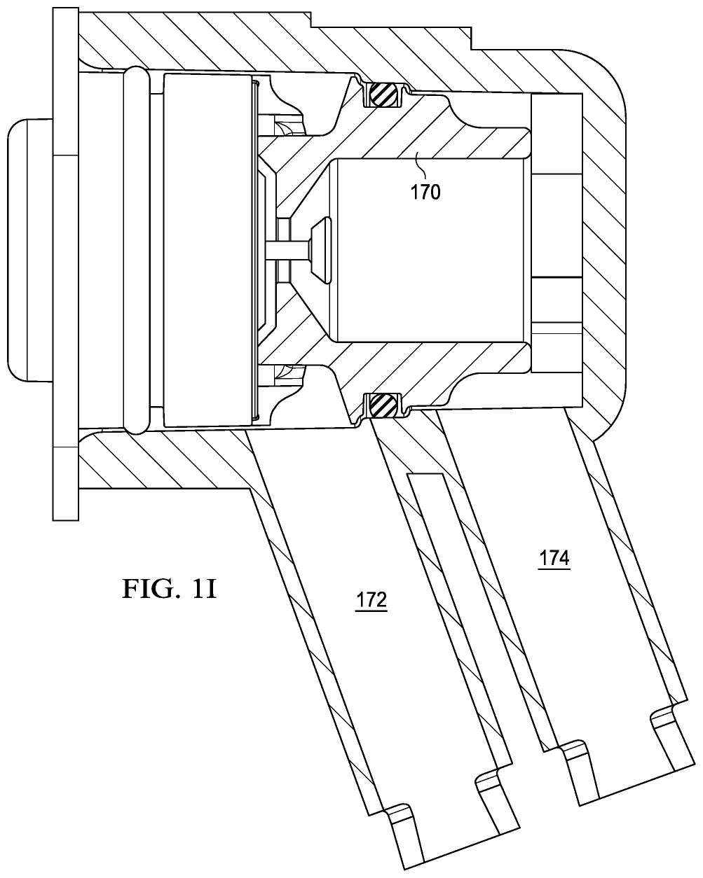

In FIG. 1A, an illustration of a CF Cartridge 100 is shown, according to one embodiment. The cartridge CF Valve 100 includes a throttle pin 102, a body 104, a body O-ring 118, a top retainer 106, a diaphragm 108, a bottom retainer 110, a spring 112, a spring cap 114, and a spring cap O-ring 116. The throttle pin 102 may be stainless steel or other material with a barbed shank and mushroom shape head. The throttle pin throttles flow of fluid through the inlet orifice. The body 104 (or the CF Valve body and/or the cartridge CF Valve body) may be molded plastic forming the inlet passage. The diaphragm 108 (and/or the diaphragm chamber) is a 360 degree outlet passage and diaphragm sealing surface. The body O-ring 118 is a rubber that seals the fluid functioning part of the cartridge from the housing. The top retainer 106 is a plastic which forms the top half of the diaphragm assembly where the diaphragm 108 is sandwiched between the two retainers (e.g., top retainer 106 and the bottom retainer 110) to form a seal. There is a molded cavity in the upper retainer (e.g., top retainer 106) that positions the barbed shank of the throttle pin 102. The cavity may be machined and/or any other process of manufacturing a cavity.

The diaphragm 108 is a flexible rubber (and/or any other flexible material) shaped to form a seal between the fluid section and the dry section of the spring cavity. The flex of the diaphragm 108 allows the throttle pin 102 to move in response to the spring pressure and inlet pressure thus modulating the fluid flow through the inlet orifice. The bottom retainer 110 is a plastic part which may be welded (and/or press fitted, and/or any other attachment procedure (e.g., glued, stamped, etc.) to the upper retainer (e.g., top retainer 106) to form the diaphragm assembly. The bottom retainer 110 also positions the spring 112 in the spring cap 114. The spring 112 is stainless steel (and/or other similar material—non corrosive material—the material can be a corrosive material also since the area is dry) and serves to keep the diaphragm 108 seated against the sealing ring of the body 104 until there is sufficient input pressure to compress the spring opening the valve for normal operation. As the throttle pin 102 is fastened (could sit on top of—further the spring may not be fastened buy sits against cap and retainer) to the diaphragm assembly, when the inlet pressure depresses the diaphragm 108/spring 112 the throttle pin 102 closes the inlet orifice reducing the flow/pressure. There is continuous movement of the spring 112, the diaphragm assembly and the throttle pin 102 as the valve modulates and maintains the preset fixed operating pressure.

The spring cap 114 is usually plastic but can be any material stiff enough to mitigate any movement of the material that would change the length of the spring cap cavity. The length of the cavity is critical because the spring 112 must be preset and/or compressed to the operating load before the cartridge CF Valve 100 is put into operating. It should be noted that the spring cap 114 creates the seal by compressing the diaphragm 108 to the body 104. The rubber cap “O” ring is to form a seal so the passage of the fluid from the body 104 through the housing cannot leak out around the spring cap 114.

In FIG. 1B, another illustration of the cartridge CF Valve 100 is shown, according to one embodiment. In this example, the cartridge CF Valve 100 is shown assembled.

In FIG. 1C, another illustration of the cartridge CF Valve 100 is shown, according to one embodiment. In this example, the cartridge CF Valve 100 is shown in a cross sectional view. It should be noted that the cartridge CF Valve 100 shown in FIGS. 1A-1D are 90 degree versions of the CF Valve configuration. In the 90 degree version, the CF Valve is configured to maintain a relative constant flow of fluid from a variable pressure fluid supply to a fluid outlet, the CF Valve may include: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice. It should be noted that any characteristics and/or features shown and/or described in relation to the 90 degree version can be utilized with the cartridge CF Valve 100.

In another example, a straight through version of the CF Valve can be utilized with any feature and/or function shown and/or described in relation to the the cartridge CF Valve 100. In this example, the CF Valve is configured to maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice. It should be noted that any characteristics and/or features shown and/or described in relation to the straight through version can be utilized with the cartridge CF Valve 100. In this example, an outlet port 124 is at a 90 degree angle to the inlet port.

In FIGS. 1E-1G, illustrations of the cartridge CF Valve 120 being placed into a chamber of a device 130, according to various embodiments. In one example, the cartridge CF Valve 120 is placed in a modular unit and locked into placed by a locking device 132.

FIG. 1G shows a manifold 140 of a device, according to one embodiment. In this example, one or more cartridge CF Valve 100 and/or one or more cartridge CF Valve 120 may be utilized with and/or placed inside the manifold 140.

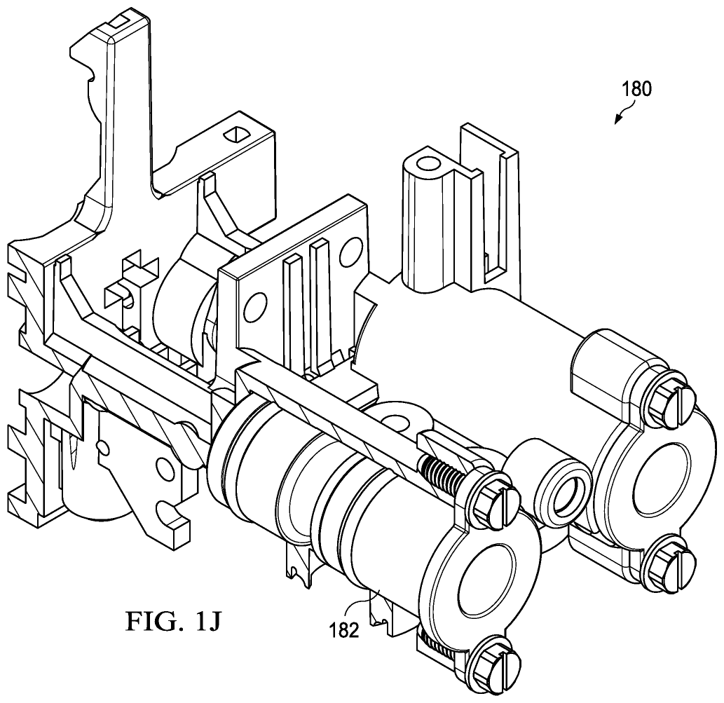

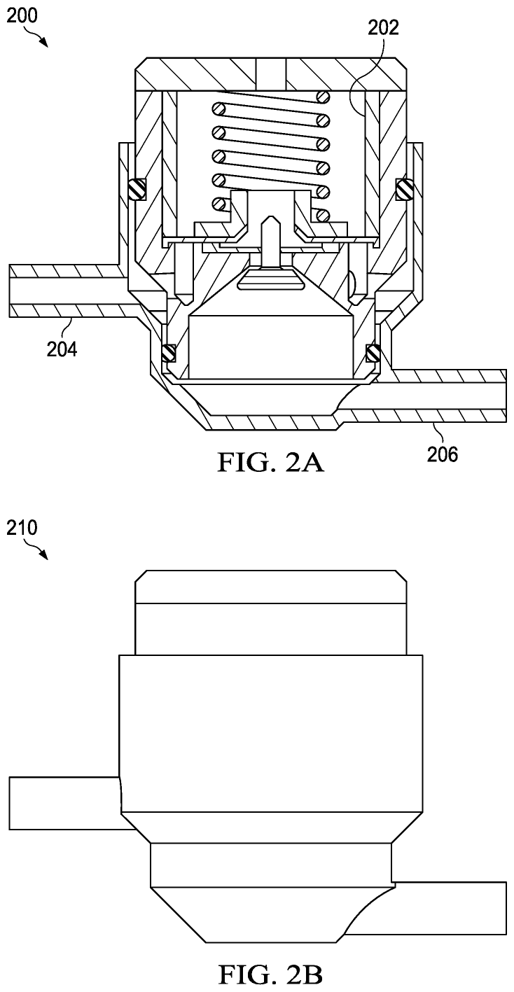

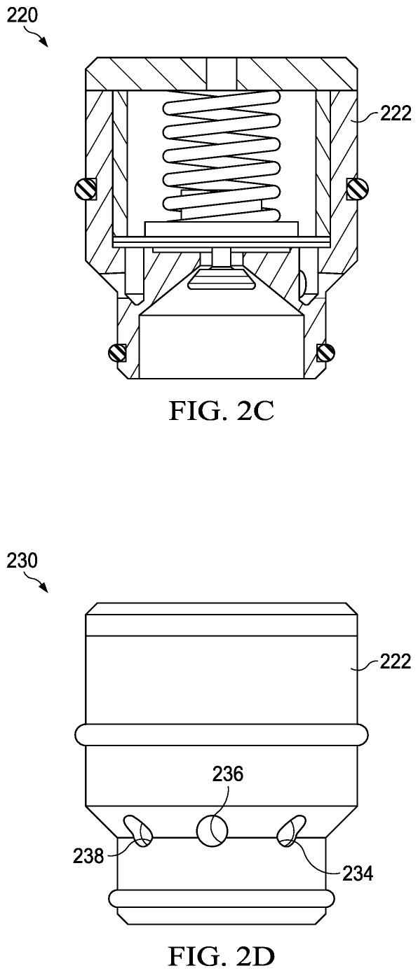

FIG. 1H shows an illustration 150 of a first cartridge CF Valve 152 and an Nth cartridge CF Valve 158 combined via combining device 160 and inserted into an existing device 154 with an existing outlet 156. In another example shown in FIG. 1I, a cartridge CF Valve 170 is placed in a housing that has an inlet port 174 and an outlet port 172 which are adjacent and parallel with each other. In another example shown in FIG. 1J, a cartridge CF Valve 182 is utilized in a retrofit configuration. Further as shown in FIGS. 2A-2B, the cartridge CF Valve 202 may have an inlet port 206 and an outlet port 204 which are parallel with each other but offset from each other. FIG. 2B shows another illustration 210 of the cartridge CF Valve 202.

In FIGS. 2C-2D, the cartridge CF Valve 222 is shown with one or more ports (e.g., a first port 234, a second port 236, and an Nth port 238). These ports (e.g., a first port 234, a second port 236, and an Nth port 238) can be utilized as inlet port and/or outlet ports which allows for easier retrofitting application. The retrofitting is easier because the flow of a liquid and/or gaseous mixture from an existing component with ports in any location (e.g. at a 90 degree angle, at a 180 degree angle, etc.) can be exchanged with the cartridge CF Valve 222 because the one or more ports (e.g., a first port 234, a second port 236, and an Nth port 238) can accommodate any existing condition (e.g., ports at a 90 degree angle, etc.).

In FIGS. 1A-1J, a Cartridge CF Valve is shown which can be placed inside an assembly. The Cartridge CF Valve can fit into existing equipment assemblies for ease of retrofit. The Cartridge CF Valve can have adjustable flow rates and/or factory fixed flow rates to create accurate and consistent flow and/or ratio control. The Cartridge CF Valve (body (includes pin and diaphragm assembly), spring, and cap) drops into existing manifolds (See FIGS. 1H and 1I) and secures with the preexisting or newly designed fittings. The Cartridge CF Valve is retrofit compatible with existing manifolds. Further, the Cartridge CF Valve replaces all ceramic flow controls, pressure regulators, restrictor plate style flow controls or other methods of ratio and flow control. In addition, the CFV Cartridge is designed so that the other existing parts can be reused with the Cartridge CF Valve. In addition to being retrofit compatible with existing assemblies and equipment, the Cartridge CF Valve can be integrated into new plumbing assemblies to provide for any inlet and outlet flow configuration required for a particular application. Further, some design considerations are location/placement of orifice within the assembly either for ease of adjustment/replacement or in a manner that is not or not easily replaceable/adjustable for a tamper proof flow rate and/or ratio. The Cartridge CF Valve may be designed to not require indexing for ease of installation and replacement. In other applications, the Cartridge CF Valve may be utilized without an orifice downstream, simply relying on the system backpressure to maintain a constant pressure for certain applications. Additionally, the Cartridge CF Valve allows for solenoid/electromagnetic, manual or other actuation up or downstream of the Cartridge CF Valve.

In another example shown in FIGS. 1A, 1B, and 1D, a new flow control manifold with the Cartridge CF Valve can be assembled as a single welded part each with a fixed or replaceable orifice and/or a Brix screw. This welded Cartridge CFV Valve can be integrated into an existing design or provide an entirely new flow control manifold to be secured inside existing equipment or on or under the counter for certain applications. In this example, the Cartridge CF Valve is retrofit compatible with existing flow connector (same inlets and outlets). It is simple to remove the existing flow control manifold and replace with a new flow control manifold. In this example, the existing clips/fasteners and shut off components may be reused. Design considerations are fixed or adjustable orifices and the Cartridge CF Valve can be mechanically fastened or welded. In addition, a single SKU for the entire manifold can be used and/or for each valve assembly.

The Cartridge CF Valve is designed to provide a constant rate of fluid flow at a preset pressure when coupled with a down-stream orifice. The CF Valve can be a 90 degree valve, a straight through valve, any combination thereof, and/or any other degree configuration. The Cartridge CF Valve may have a factory set operating pressure from 7.5 psi to 70 psi. In addition, a wide range of flow rates can be used (e.g., 0.01 gpm (gallons per minute) to 8 gpm and/or any other number). There are no wetted mechanicals in the CF Valve, according to one embodiment. There are no ceramics in the CF Valve, according to one embodiment. The CF Valve is self-cleaning, according to one embodiment. In one example, the inlet orifice is smaller than any internal passage. Therefore, no internal clogging occurs. There is minimal wear because the internal components only see operating pressure. In addition, there is no wear at static because there is no movement.

The CFiVe new backing block has a male part which attaches to the female part. In this example, the CFiVe backing block will turn on or turn off the liquid supply with the same knob movement that attaches the backing block to the male fitting. This means that the fluid cannot flow until the Valve is also attached, according to one embodiment. In this example, the new attachment device (male part and female part) dramatically reduces the space requirements (e.g., 1, 2, 3, 4, 5, 6, 7, 8, 9, and 10 inches) as it is smaller and does not require wire inserts for placement/removal of Valves, allowing the CFiVe backing blocks to be placed closer to one another. This allows for backing blocks to be placed closer together for applications where multiple valves are utilized and space is constrained or for applications where the location of the valve is close to the cooling or heating element or point of dispense is critical.

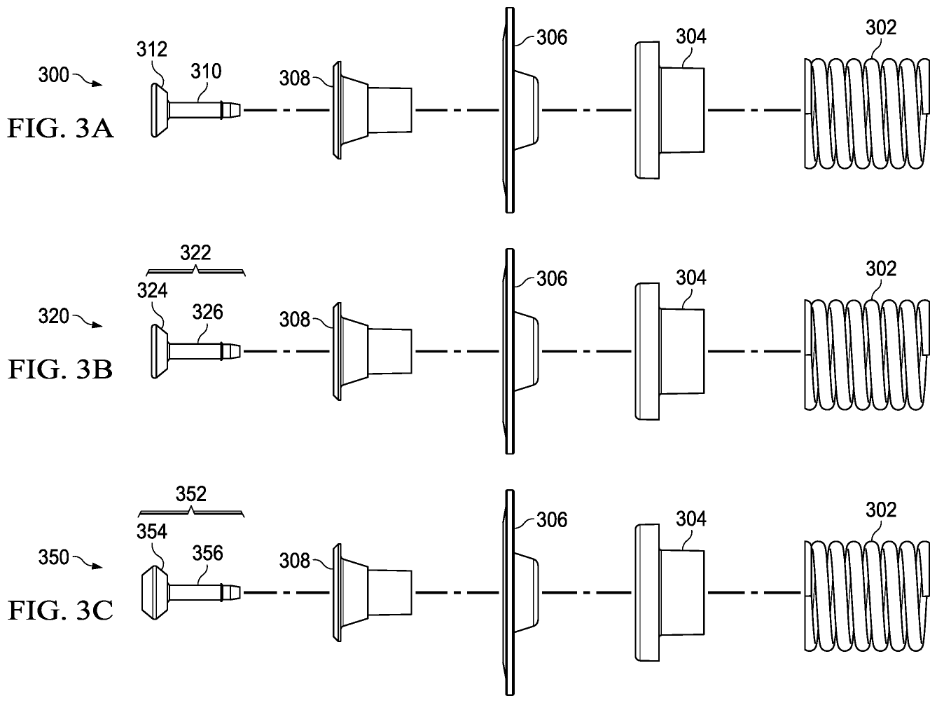

In FIG. 3A, a CF Valve with a pin 310, a pinhead 312, a top retainer 308, a diaphragm 306, a bottom retainer 304, and a spring 302 are shown. In this example, the pin 310 and the pinhead 312 are rigid material which can make production of the CF Valve more complicated and the component costs more expensive as the diaphragm assembly and the insertion of the pin through the body becomes multiple steps in the assembly process. In FIG. 3B, the pin 326 and the pinhead 324 could be all one piece 322, separate pieces molded and/or overmolded, made of rubber, made of flexible material, and/or any of type of flexible device which allows for easier insertion in the CF Valve. For proper function, the pin head must be larger than the inlet orifice. In one example, the pin is attached to the diaphragm assembly on one side of the inlet orifice and the pin head is on the other side of the inlet orifice. In another example shown in FIG. 3C, a rubber or semi-flexible plastic or metal pin 354 can be shaped so that during assembly the pin head 354 can be forced under pressure through the inlet orifice but when it comes through the other side it is properly proportioned (larger) relative to the inlet orifice. In this example, the pin, the diaphragm, and diaphragm retainers can all be molded or overmolded in one piece eliminating two assembly operations. In this example, a pin 356 and the flexible pinhead 354 can be one piece 352.

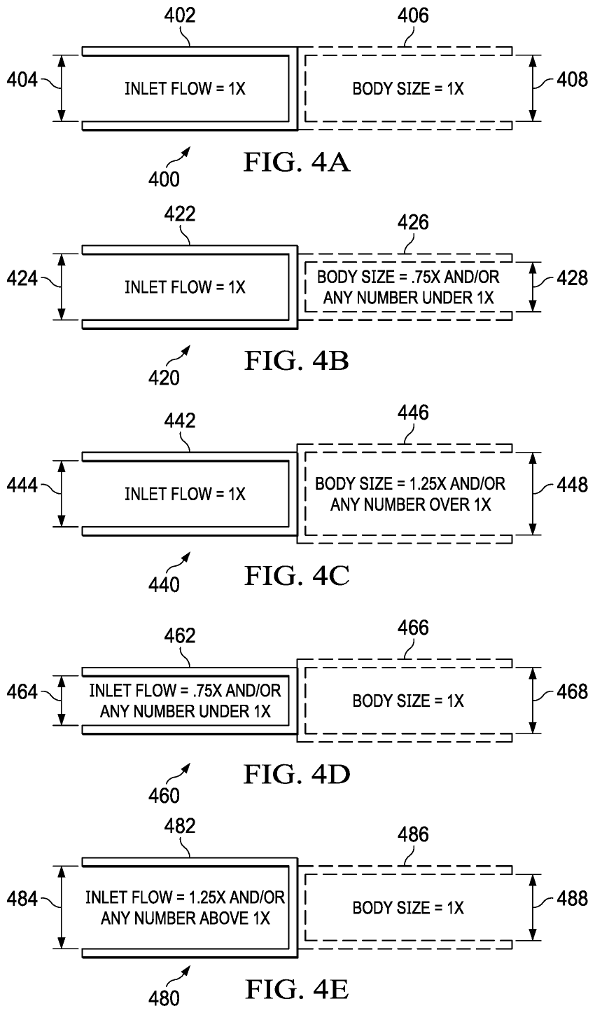

In FIG. 4A, a CF Valve 400 is shown with an inlet area 402 and a first inlet flow 404 of 1× and body 406 with a first body size 408 of 1×. In FIG. 4B, a CF Valve 420 is shown with an inlet area 422 and a second inlet flow 424 of 1× and a body 426 with a second body size 428 of 0.75× (and/or any other number (e.g., 0.9999×, . . . , 0.99×, 0.98×, etc.) under 1×). In FIG. 4C, a CF Valve 440 is shown with an inlet area 442 and a third inlet flow 444 of 1× and a body 446 with a third body size 448 of 1.25× (and/or any other number (e.g., 1.00001×, . . . , 0.1.01×, 1.02×, etc.) over 1×). In FIG. 4D, a CF Valve 460 is shown with a body 466 and a fourth body size 468 of 1× and an inlet area 462 with a fourth inlet flow size 464 of 0.75× (and/or any other number (e.g., 0.9999X, . . . , 0.99×, 0.98×, etc.) under 1×). In FIG. 4E, a CF Valve 480 is shown with a body 486 and an Nth body size 488 of 1× and inlet area 482 with an Nth inlet flow size 484 of 1.25× (and/or any other number (e.g., 1.00001×, . . ., 0.1.01×, 1.02×, etc.) over 1×). In various examples, in order to decrease/increase the size of the CF Valve, the body and pin and pin orifice are all decreased and/or increased proportionately in equal percentages so that there is a match between the body size and the pin/pin orifice size. However, in situations where the body size is restricted by the application or existing housing, there can be a need for greater (or lesser) flow through a particular sized body which requires the equal proportionate relationship to be varied between the body and the pin/pin orifice. By varying the relationship of the pin and inlet orifice to the body size, the CF Valve can be customized in flow and pressure characteristics to a particular application. This has several advantages including the ability to vary the size and/or performance without necessarily changing the internal components of the CF Valve which improves production costs, reduces assembly time, and/or may automate one or more functions. Thus the options for assembly of one or more the components are a major production cost savings. Additionally, by changing the size of the body, the CF Valves can be customized in size and flow and pressure capacity to fit each individual application.

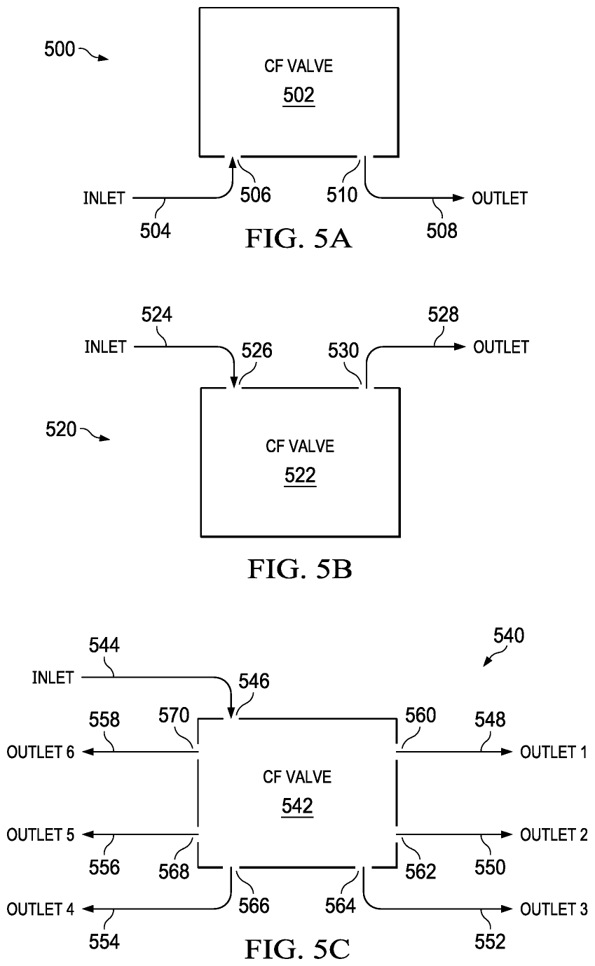

In FIG. 5A, a cartridge CF Valve 502 is shown with an inlet area 504 and an outlet flow area 508 occurring at the same dimensional side (e.g., bottom). In this example, an inlet area position 506 and an outlet flow position 510 are both located on the same side of the cartridge CF Valve 502. In FIG. 5B, a cartridge CF Valve 522 is shown with an inlet area 524 and an outlet flow area 528 occurring at the same dimensional side (e.g., top). In this example, an inlet area position 526 and an outlet flow position 530 are both located on the same side of the cartridge CF Valve 522. In FIG. 5C, a cartridge CF Valve 542 is shown with an inlet area 544, a first outlet flow area 548, a second outlet flow area 550, a third outlet flow area 552, a fourth outlet flow area 554, a fifth outlet flow area 556, and/or an Nth outlet flow area 558 with outlet flow area positions (e.g., 560, 562, 564, 566, 568, and/or 570). These outlet flow area are occurring at different dimensional side then the inlet area 544 and/or the inlet area position 546. For example, the inlet flow occurs at the top of the cartridge CF Valve while the outlet flow could occur on the right side, the bottom, and/or the left side. In these various examples and/or embodiments, being able to take advantage of the multi-directional characteristic allows for enhanced adaptability to fit into existing systems, devices, and/or equipment.

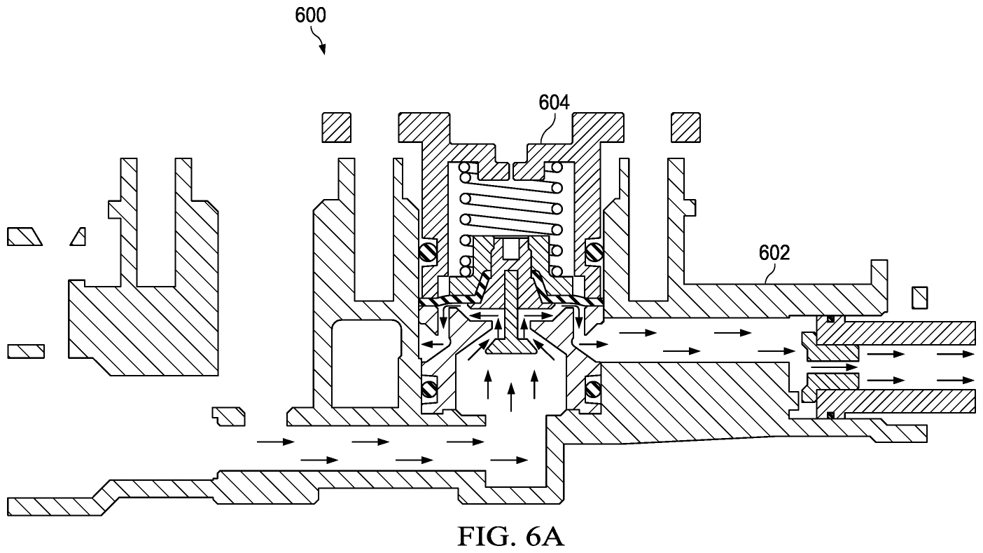

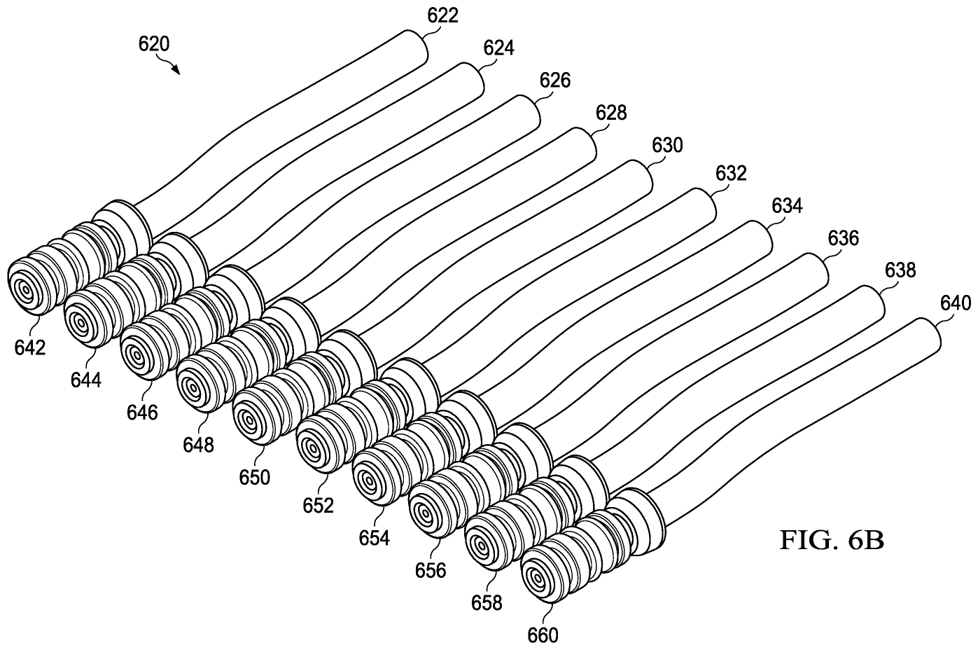

In FIG. 6A, a bar gun 602 is shown with a control orifice inside the bar gun which may be set to factory settings. The Cartridge CF Valve 604 can be assembled with the orifice inside the CF Valve a factory set flow rate to eliminate tampering with the orifice and therefore the flow rates. The cartridge CF Valve is symmetrical so that no indexing is required when assembling. The spring cap is sized and molded to be slightly loose on the housing so that if the stack tolerances are all on the plus side the pressure on the diaphragm will still be sufficient to cause a seal. In another example, the cartridge CF Valve may have a fixed orifice. In another example, the orifice may be in the outlet side which also the orifice to be replaceable. It should be noted that the disclosure relating to the bar gun may be utilized with any other equipment in this disclosure. Further, all disclosures relating to one element (e.g., the ball, the CF Valve, the Cartridge CF Valve, the backing block, the needle, etc.) may be utilized with any other disclosure relating to any other element (e.g., the ball, the CF Valve, the Cartridge CF Valve, the backing block, the needle, etc.). For example, the ball disclosure may be combined with the cartridge CF Valve disclosure. Further, one feature (and/or one or more features) of the ball disclosure may be combined with one feature (and/or one more features) of the cartridge CF Valve disclosure. For brevity, all of the other items disclosed in this disclosure will not be listed out but are inherently combinable in this disclosure.

In FIG. 6B, a bar gun feeding system 620 is shown. The bar gun feeding system 620 may include a first liquid and/or gaseous mixture line 622 with a first cartridge CF Valve 642, a second liquid and/or gaseous mixture line 624 with a second cartridge CF Valve 644, a third liquid and/or gaseous mixture line 626 with a third cartridge CF Valve 646, a fourth liquid and/or gaseous mixture line 628 with a fourth cartridge CF Valve 648, a fifth liquid and/or gaseous mixture line 630 with a fifth cartridge CF Valve 650, a sixth liquid and/or gaseous mixture line 632 with a sixth cartridge CF Valve 652, a seventh liquid and/or gaseous mixture line 634 with a seventh cartridge CF Valve 654, an eighth liquid and/or gaseous mixture line 636 with an eighth cartridge CF Valve 656, a ninth liquid and/or gaseous mixture line 66 with a ninth cartridge CF Valve 66, and/or an Nth liquid and/or gaseous mixture line 640 with an Nth cartridge CF Valve 660. In should be noted that one or more of the first cartridge CF Valve 642, the second cartridge CF Valve 644, the third cartridge CF Valve 646, the fourth cartridge CF Valve 648, the fifth cartridge CF Valve 650, the sixth cartridge CF Valve 652, the seventh cartridge CF Valve 654, the eighth cartridge CF Valve 656, the ninth cartridge CF Valve 66, and/or the Nth cartridge CF Valve 660 may have different settings, mixture ratios, flow rates, and/or any other characteristic based on the liquid and/or gaseous mixture running through their respective lines. For example, a first liquid and/or gaseous mixture running through the first liquid and/or gaseous line 622 may require a cartridge CF Valve setting of one (e.g., flow rate is X, pressure is Y, etc.). Whereas, a second liquid and/or gaseous mixture running through the second liquid and/or gaseous line 624 may require the cartridge CF Valve setting of two (e.g., a flow rate different than X, a pressure different than Y, etc.).

In one example, a CF Valve may encounter with a line pressure of 100 PSI and an outlet pressure of 40 PSI when the outlet is open. Further, the CF Valve may encounter a line pressure of 100 PSI and an outlet pressure of 100 PSI because the pin is not closed. In addition, the CF Valve may encounter a line pressure of 100 PSI and an outlet pressure of 46 PSI because the pin is closed.

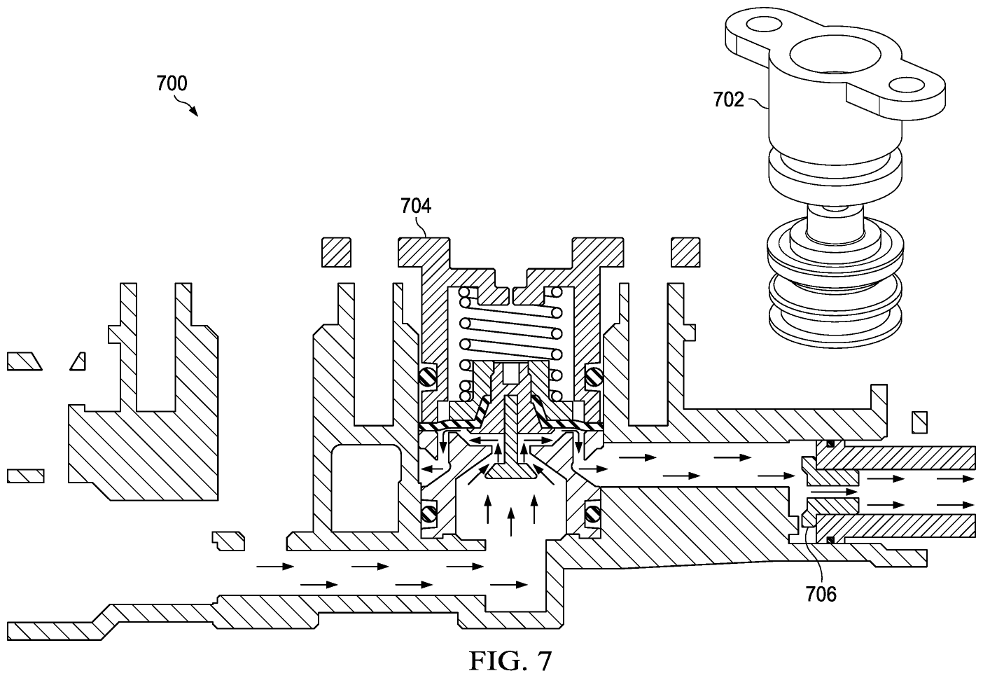

In FIG. 7, an illustration of CF Valve with an orifice 700 is shown, according to one embodiment. In this example, the CF Valve cartridge provides flow control to the device. Further, an orifice 706 may be fixed or adjustable. In one example, a fixed orifice for a syrup type is pressed inside interconnected fitting. This may provide easy access via the flow control manifold connection. In another example, a variable orifice for a syrup type is pressed inside the interconnected fitting. Therefore, the flow rate may be modified via access from the flow control manifold connection.

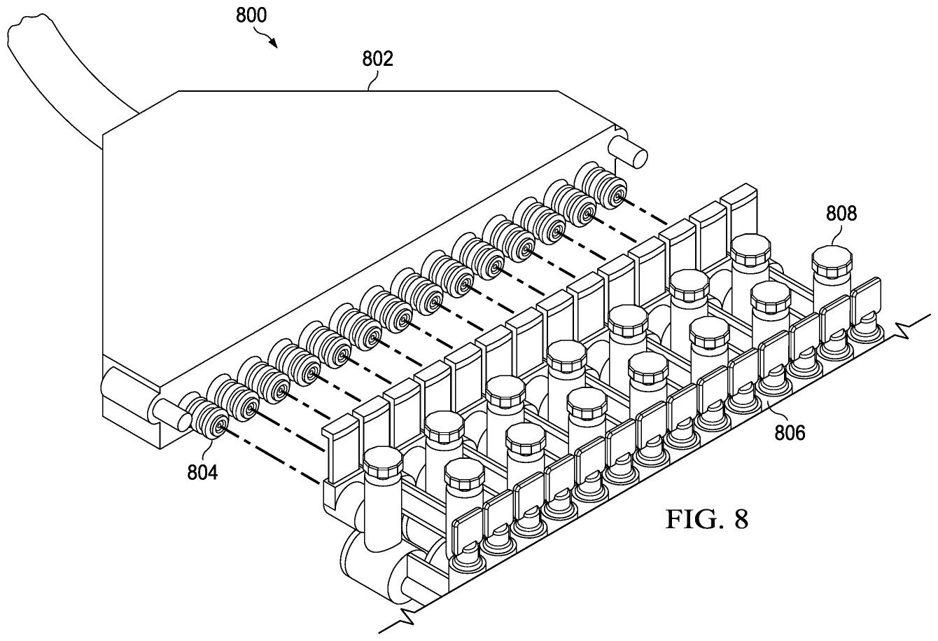

In FIG. 8, an illustration of CF Valves with orifices 800 is shown, according to one embodiment. The CF Valves with orifices 800 may include a bar gun base 802, one or more orifices 804, a CF Valve manifold, one or more CF Valves 808, and one or more shut off devices 806.

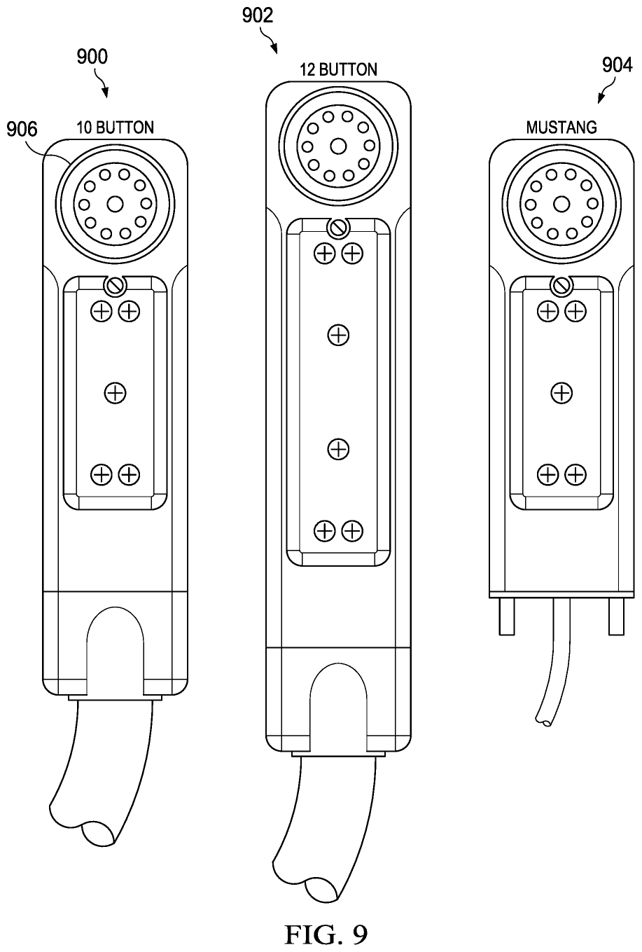

FIG. 9 shows various illustrations of a bar gun, according to a couple of embodiments. In a first example, a 10 button bar gun 900 with a diffuser 906 is shown. In another example, a 12 button bar gun 902 with a diffuser is shown. In an Nth example, a mustang bar gun 904 with a diffuser is shown. Any type of bar gun can be utilized with any example, embodiment, and/or feature described in this disclosure.

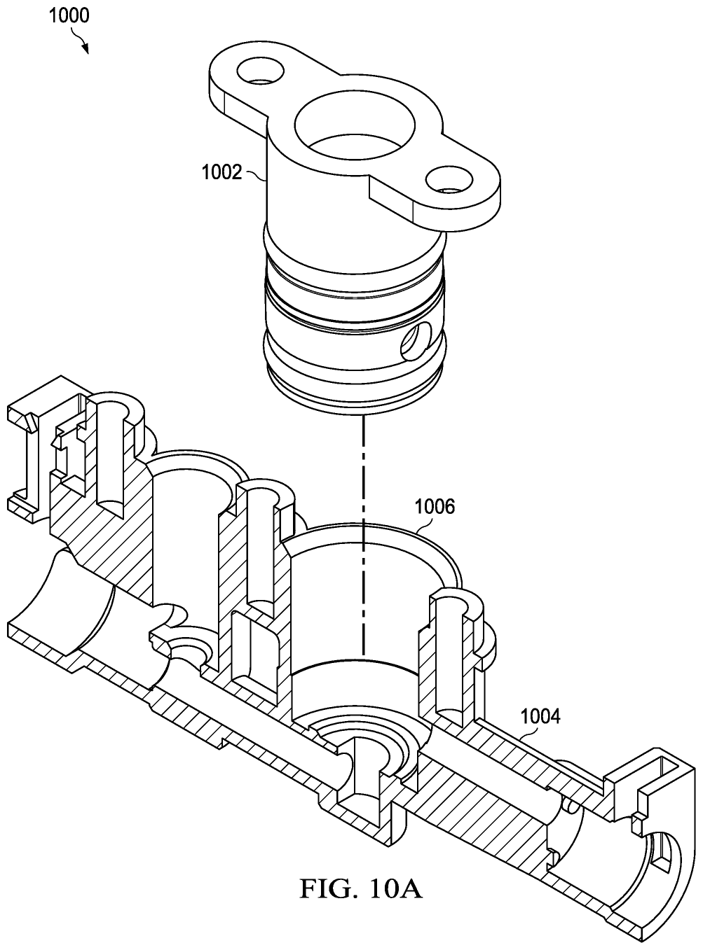

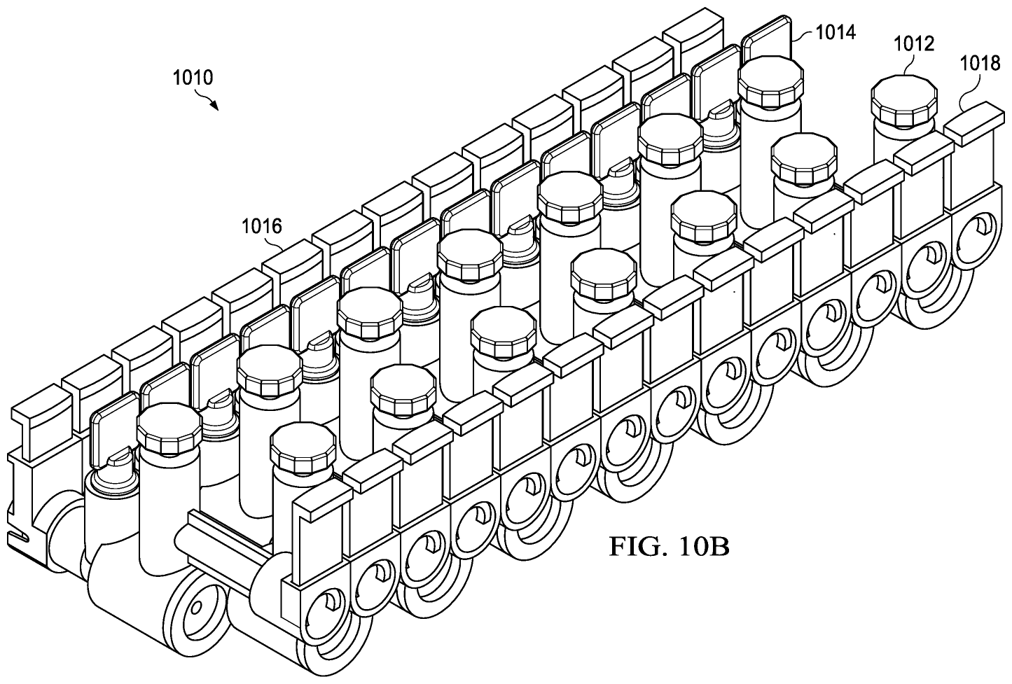

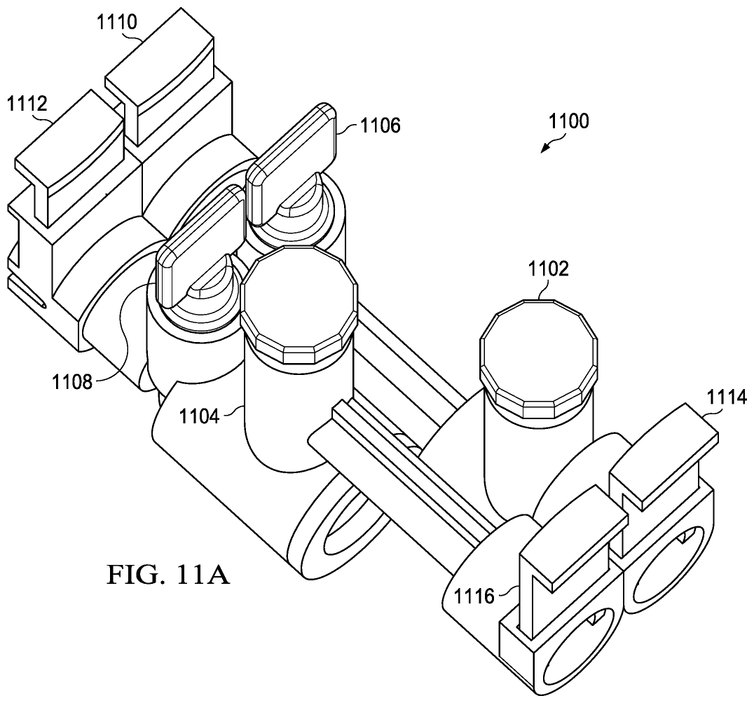

In FIG. 10A, an illustration of CF Valve being placed into a bar gun application 1000 is shown, according to one embodiment. In this example, a CF Valve 1002 is being placed into a bar gun device 1004 via CF Valve holding area 1006.

In FIG. 10B, an illustration of CF Valve manifold utilized in a bar gun application 1010 is shown, according to one embodiment. In this example, a CF Valve manifold 1010 includes a first set of quick connect devices 1016, a second set of quick connect devices 1018, one or more CF Valves 1012, and one or more shut off devices 1014.

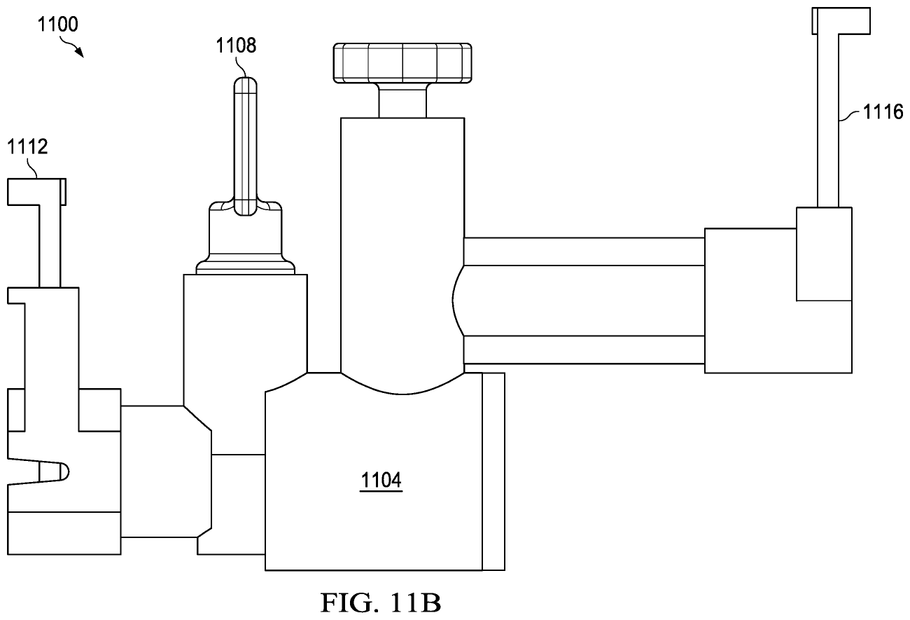

In FIG. 11A, an illustration of CF Valve in a bar gun application 1100 is shown, according to one embodiment. In one example, the CF Valve device 1100 includes a first CF Valve 1102, a second CF Valve 1104, a first shut off device 1106, a second shut off device 1108, a first connection device 1110, a second connection device 1112, a third connection device 1114, and a fourth connection device 1116. In one example, the new manifold with cartridge CF Valve each valve is a single part (welded cartridge) with brix screw and shot off and new rack to secure under a counter with the same footprint and screw pattern as an existing device. In this retrofit example, the device may have the same inlets and outlets which allows for easy removal of the existing flow control and replacement with the new CF Valve manifold. In various examples, the CF Valve manifold may utilize fixed and/or adjustable orifices. FIG. 11B is another illustration of CF Valve in a bar gun application 1100.

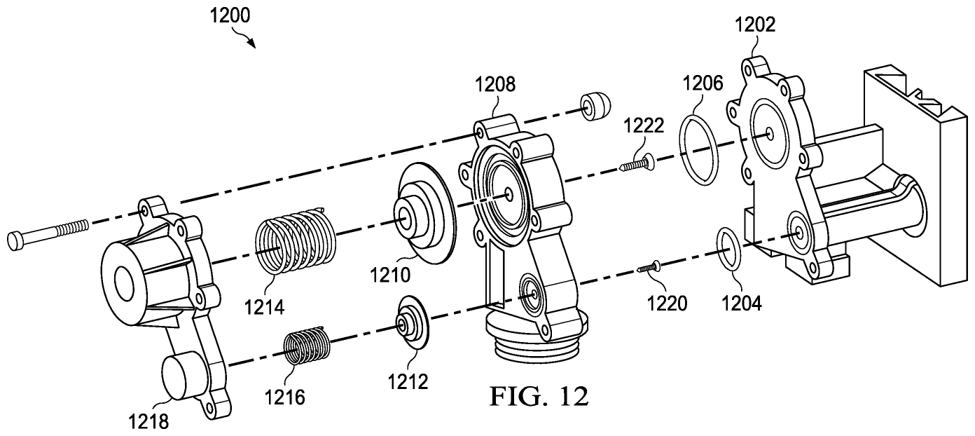

In FIG. 12, an illustration of a CF Valve device 1200 is shown, according to one embodiment. The CF Valve device 1200 includes a CF Valve inlet mount 1202, a first assembly O-ring 1204, a second assembly O-ring 1206, a first throttle pin 1220, a second throttle pin 1222, a CF Valve body 1208, a first CF Valve diaphragm assembly 1210, a second CF Valve diaphragm assembly 1212, a first CF Valve spring 1214, a second CF Valve spring 1216, a CF Valve spring cup 1218, and various fasteners, according to one embodiment. In this example, this integrated part requires no maintenance to the part. In one example, the throttle pins are 1.0× & 1.75× CF Valve throttle pins. In another example, the CF Valve body 1208 is 1.75× and 1.0× CF Valve body. In another example, the first CF Valve diaphragm assembly 1210 is 1.75× CF Valve diaphragm assembly. In another example, the second CF Valve diaphragm assembly 1212 is 1.0× CF Valve diaphragm assembly. In one example, the first CF Valve spring 1214 is 1.75× CF Valve spring. In another example, the second CF Valve spring 1216 is 1.0× CF Valve spring. In various embodiments, these examples may be mixed and matched. Further, any example, embodiment, and/or feature in this disclosure may be combined with any other example, embodiment, and/or feature in this disclosure.

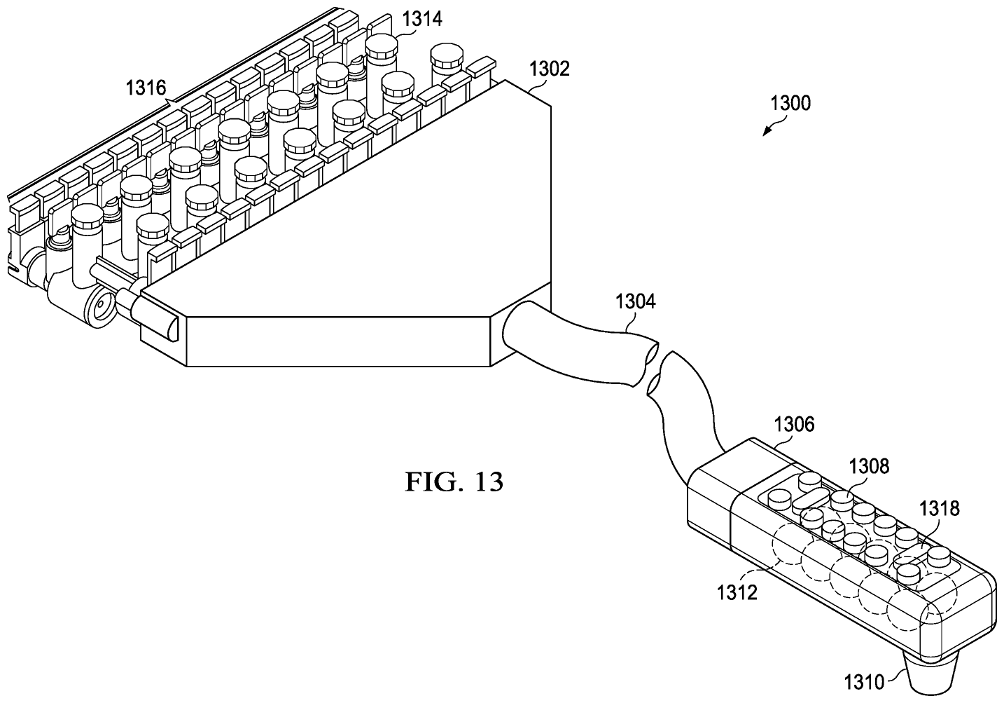

In FIG. 13, an illustration of a CF Valve device in a bar gun application 1300 is shown, according to one embodiment. The CF Valve device in a bar gun application 1300 may include one or more fluid and/or gas sources (e.g., water, carbon, nitrogen, carbonated water, syrup, etc.) 1316, one or more CF Valves 1314, a bar gun connector 1302, a bar gun hose 1304, and a bar gun 1306. The bar gun 1306 may include one or more flavor buttons 1308, one or more water or gas buttons 1318, one or more solenoids 1312, and a diffuser 1310.

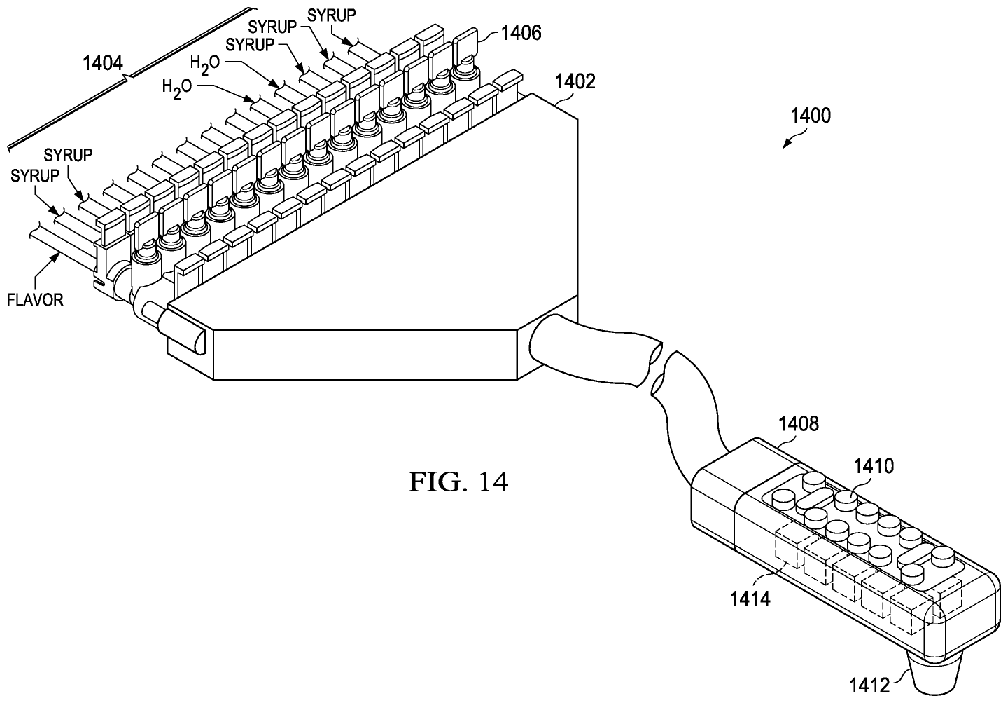

In FIG. 14, an illustration of a CF Valve device in a bar gun application 1400 is shown, according to one embodiment. The CF Valve device in a bar gun application 1400 may include a bar gun connection device 1402, one or more fluid or gas sources 1404 (e.g., water, carbon, carbonated water, nitrogen, syrup 1, syrup 2, . . . , syrup N), one or more shut off devices 1406, and a bar gun 1408. In one example, the bar gun 1408 may include one or more buttons 1408, a diffuser 1412 and one or more built-in CF Valves 1414.

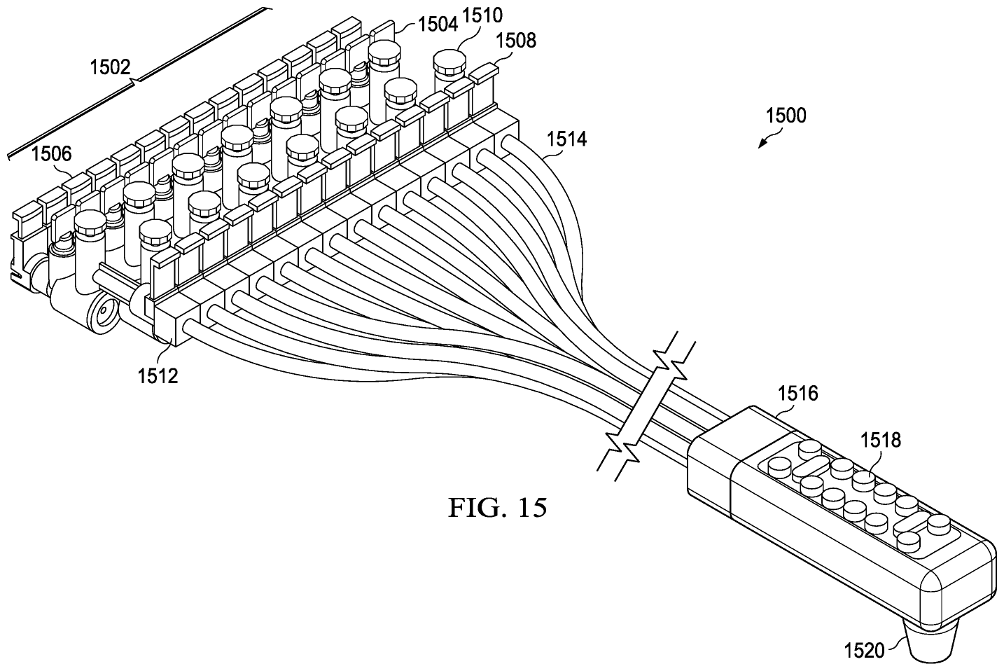

In FIG. 15, an illustration of a CF Valve device in a bar gun application 1500 is shown, according to one embodiment. The CF Valve device in a bar gun application 1500 may include one or more fluid or gas sources 1502 (e.g., water, carbon, carbonated water, nitrogen, syrup 1, syrup 2, . . . , syrup N), one or more shut off devices 1504, a first set of connection devices 1506, a second set of connection devices 1508, one or more CF Valves 1510, one or more solenoids 1512, one or more hoses 1514, and a bar gun 1516 with one or more buttons 1518 and a diffuser 1520. In various examples, one or more solenoids 1512 may be downstream or upstream and/or a combination of both relative to the one or more CF Valves 1510.

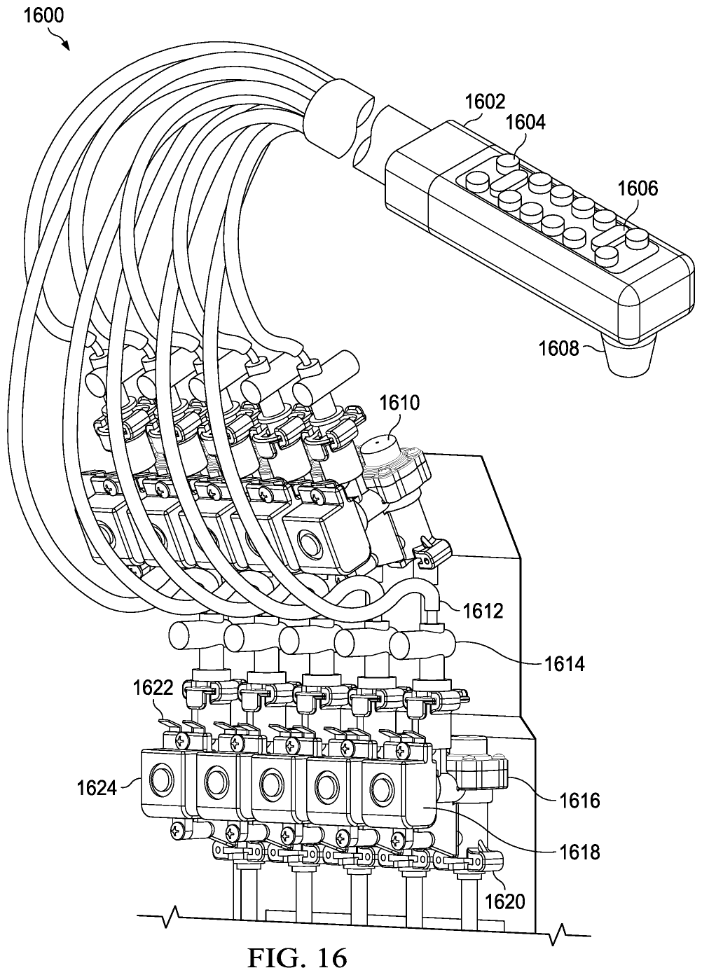

In FIG. 16, an illustration of a CF Valve device in a bar gun application 1600 is shown, according to one embodiment. The CF Valve device in a bar gun application 1600 may include a bar gun 1602 with one or more flavor buttons 1604, one or more water and/or gas buttons 1606, and a diffuser. The CF Valve device in a bar gun application 1600 may further include a first CF Valve 1610, one or more hoses 1612, one or more outlet with fixed or adjustable flow inserts/orifices 1614, a second CF Valve 1616 (or Nth CF Valve), an isolation solenoid 1618, a quick connect inlet fitting 1620, an electrical connection 1622, and/or a solenoid with isolation diaphragm 1624.

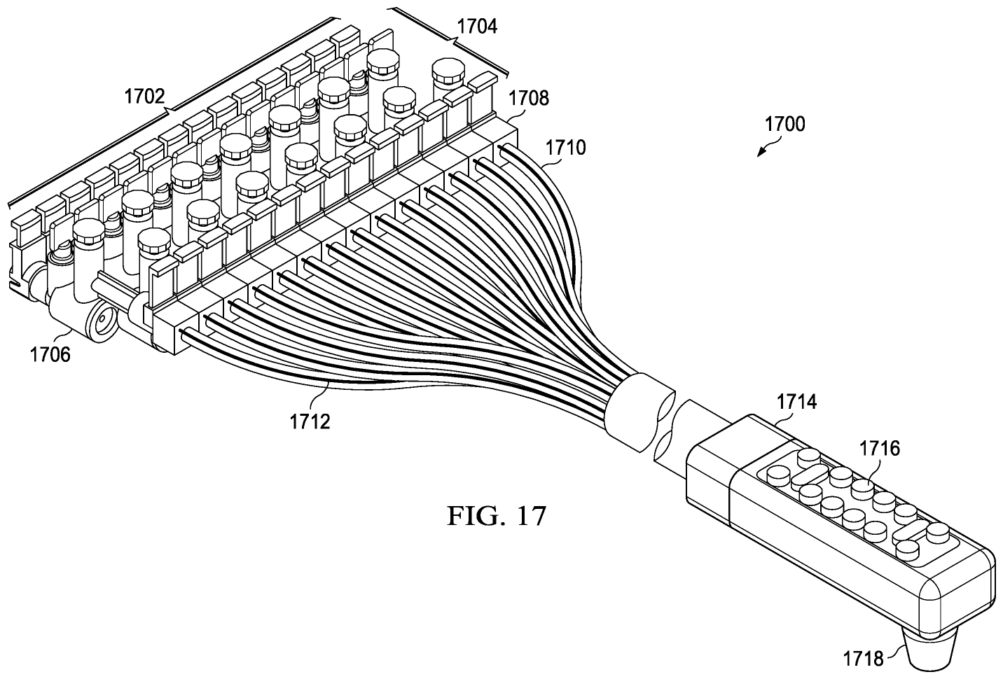

In FIG. 17, an illustration of a CF Valve device in a bar gun application 1700 is shown, according to one embodiment. The CF Valve device in a bar gun application 1700 may include one or more fluid or gas sources 1702 (e.g., water, carbon, carbonated water, nitrogen, syrup 1, syrup 2, . . . , syrup N), a CF Valve manifold 1704 with one or more CF Valves 1706, one or more solenoids 1708, one or more tubes 1710, one or more wires 1712, and a bar gun 1714 with one or more buttons 1716 and a diffuser 1718. In various examples, the CF Valve device in a bar gun application 1700 may provide: flavor shots or essence; a combination of flavors; and more flavors and/or drinks without increasing the size of the bar gun 1714. In addition, the CF Valve device in a bar gun application 1700 reduces cost, increases accuracy and quality of the drinks, reduces leaks and reduces maintenance. In another example, the buttons actuate the solenoid. In another example, traditional water proof wiring can be utilized. In another example, micro controllers at the bar gun with signal wire to the solenoid may be utilized. In another example, RFID or other wireless technology may be utilized. In addition, fiber optics can be utilized.

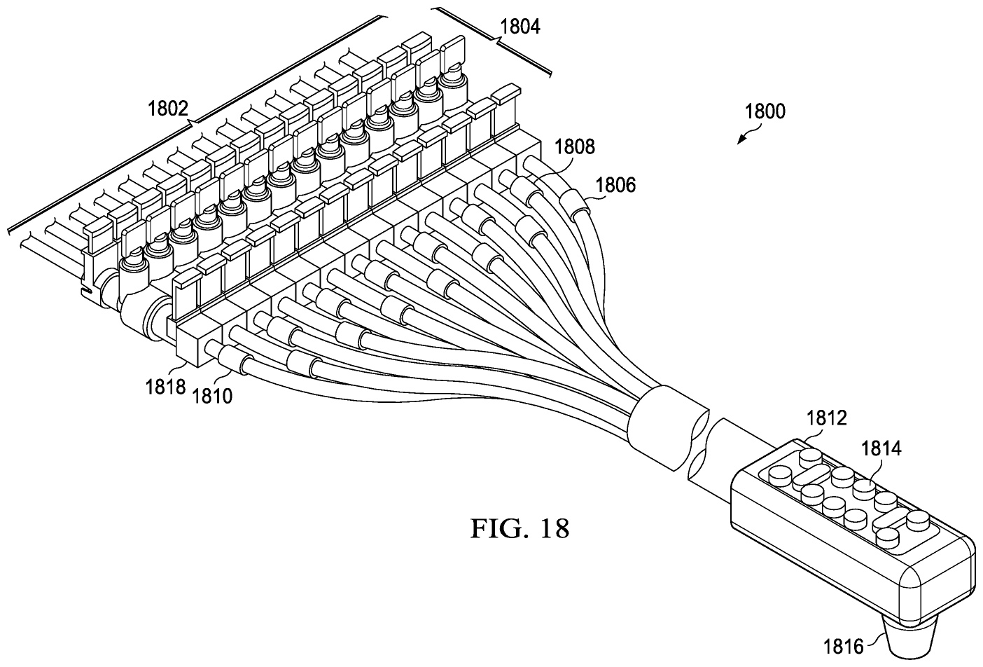

In FIG. 18, an illustration of a CF Valve device in a bar gun application 1800 is shown, according to one embodiment. The CF Valve device in a bar gun application 1800 may include one or more fluid or gas sources 1802 (e.g., water, carbon, carbonated water, nitrogen, syrup 1, syrup 2, . . . , syrup N), a CF Valve manifold 1804, one or more solenoids 1818, a first CF Valve 1806, a second CF Valve 1808, an Nth CF Valve 1810, and a bar gun 1812 with one or more buttons 1814 and a diffuser 1816. In one example, the one or more solenoids 1818 are not present. Further, in various examples, the one or more CF Valves (e.g., the first CF Valve 1806, the second CF Valve 1808, and/or the Nth CF Valve 1810) are staggered or separate in the tubing of the hose(s). This configuration may allow for a physically smaller bar gun 1812. In another example, sets of CF Valves may be staggered or separated. For example, a first group or set of CF Valves may be located at a position X of their respective tube or hose while a second group of set of CF Valves may be located at a position Y of their respective tube or hose while an Nth group or set of CF Valves may be located at a position Z of their respective tube or hose.

In light of the foregoing, it will now be appreciated by those skilled in the art that the present disclosure embodies a number of significant advantages, the foremost being the automatic pressure responsive control of fluid flow between a variable pressure source and an applicator from which the fluid is to be applied in a substantially uniform manner. The regulating valve is designed for low cost mass production, having a minimum number of component parts, the majority of which can be precision molded and automatically assembled.

In one example, a regulating valve for maintaining a substantially constant flow of fluid from a variable pressure fluid supply to a fluid outlet includes: a housing having axially aligned inlet and outlet ports adapted to be connected respectively to the fluid supply and the fluid outlet, and a diaphragm chamber interposed between the inlet and outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported exclusively by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring in the cup coacting with the base of the piston assembly for resiliently urging the diaphragm into a closed position against the inner side of the barrier wall to thereby prevent fluid flow from the inlet port via the first passageway into the diaphragm chamber; and the spring being responsive to fluid pressure above a predetermined level applied to the diaphragm via the inlet port and the first passageway by resiliently accommodating movement of the diaphragm away from the inner side of the barrier wall, with the valve head on the stem being correspondingly moved to adjust the size of the control orifice, thereby maintaining a substantially constant flow of fluid from the inlet port through the first and second passageways to the outlet port for delivery to the fluid outlet.

In another example, a regulating valve for controlling the flow of fluid from a variable pressure fluid supply to a fluid outlet includes: a housing having axially aligned inlet and outlet ports adapted to be connected respectively to the fluid supply and the fluid outlet, and a diaphragm chamber interposed between the inlet and outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being supported exclusively by the circular rim and having a peripheral flange overlapping the cylindrical side wall; a piston assembly secured to the center of the diaphragm, the piston assembly having a base projecting into the interior of the cup; a spring in the cup coacting with the base of the piston assembly for resiliently urging the diaphragm into a closed position against the inner side of the barrier wall to thereby prevent fluid flow from the inlet port via the first passageway into the diaphragm chamber; and the spring being responsive to fluid pressure above a predetermined level applied to the diaphragm via the inlet port and the first passageway by resiliently accommodating movement of the diaphragm away from the inner side of the barrier wall, thereby accommodating a flow of fluid from the inlet port through the first and second passageways to the outlet port for delivery to the fluid outlet.

In another example, the control orifice is defined by frusto conical surfaces on the valve head and the outer side of the barrier wall. In another example, the cross sectional area of the control orifice is less than the cross sectional area of the first passageway throughout the range of movement of the valve head in response to fluid pressure applied to the diaphragm. In another example, the regulating valve further includes a vent passageway leading from the interior of the cup to the exterior of the housing. In another example, the housing is exteriorly provided with a deflecting surface adjacent to the outlet of the vent passageway, the deflecting surface being configured and arranged to direct fluid escaping from the interior of the cup in the general direction of fluid flowing through the valve, but angularly away from the valve axis. In another example, the base of the piston assembly is spaced from the bottom wall of the cup by an open gap, and wherein the spring means comprises a coiled spring bridging the gap and in contact at its opposite ends with the bottom wall and the base. In another example, the piston assembly is centered within the cup solely by the resilient support provided by the diaphragm. In another example, the housing is comprised of mating plastic inlet and outlet sections, the sections being formed by injection molding and being permanently assembled one to the other by sonic welding. In another example, the cap and base of the piston assembly are each injection molded of plastic and joined one to the other by sonic welding, with a central portion of the diaphragm held therebetween.

In one example, a dispensing device includes a valve configured to interact with an inlet stream, the inlet stream having a first pressure, the valve having an outlet area with an outlet stream, the outlet stream having a second pressure, and a solenoid which interacts with the outlet stream. In addition, the dispensing device may have: at least one of the inlet stream and the outlet stream being a carbonated water; the first pressure is greater than the second pressure; a size of the solenoid is reduced based on a reduction in pressure from the first pressure to the second pressure; a size of the solenoid is reduced based on the valve; the inlet stream is a utility line; the orifice is fixed; the orifice is adjustable; the orifices are both fixed and adjustable; and the valve is a CF Valve. The CF Valve is a regulating valve for maintaining a substantially constant flow of fluid from a variable pressure fluid supply to a fluid outlet, the CF Valve may including one or more of: a) a housing having axially aligned inlet and outlet ports adapted to be connected respectively to the variable fluid supply and the fluid outlet; b) a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; c) a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; d) a resilient disc-shaped diaphragm closing the open mouth of the cup, the diaphragm being axially supported by the circular rim and having a peripheral flange overlapping the cylindrical side wall; e) a piston assembly secured to the center of the diaphragm, the piston assembly having a cap on one side of the diaphragm facing the inner side of the barrier wall, and a base suspended from the opposite side of the diaphragm and projecting into the interior of the cup; f) a stem projecting from the cap through the first passageway in the barrier wall to terminate in a valve head, the valve head and the outer side of the barrier wall being configured to define a control orifice connecting the inlet port to the diaphragm chamber via the first passageway; and g) a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

In another example, the dispensing device may further include: a dispensing unit including one or more flavor units and one or more water units where each of the one or more flavor units include a transportation unit, the transportation unit including a barrier element with one or more openings; a blockage device configured to close the one or more openings to prevent a flow from at least one of the one or more flavor units; and/or a movement device configured to move the blockage device to a first position relative to the one or more openings which allows for a passage of one or more fluid elements and one gaseous elements through the one or more openings in the blockage device.

The dispensing device may further include a carbonated unit. In another example, the movement device is a magnet. In another example, the movement device is an electro-magnet. In another example, the dispensing device may have at least one of the one or more flavor units may be selectable. In addition, the at least one of the one or more flavor units may be automatically selectable.

In one embodiment, the cartridge includes: a body with a first groove and a second groove, the body including a body inlet area and a body outlet area; an o-ring coupled to body via the first groove; a throttle pin coupled to the inlet area; a spring cap with a groove area, a spring cap inlet area, and a spring cap outlet area; a spring cap o-ring coupled to the spring cap via the groove area; a spring coupled to a bottom retainer; a diaphragm coupled to the bottom retainer; and a top retainer coupled to the diaphragm.

In addition, the cartridge may be configured to be inserted into a device. Further, the cartridge may be configured to be inserted into an existing device where the existing device has one or more inlet ports and outlet ports in any locations on the existing device. In addition, a cartridge inlet area and a cartridge outlet area may be in series with each other. Further, a cartridge inlet area and a cartridge outlet area may be at a 90 degree angle to each other (and/or any other angle and/or any other angle disclosed and/or shown in this document). In addition, the body may include a 360 degree outlet passage. Further, the spring cap may be configured to create a seal by compressing the diaphragm to the body. Further, the cartridge may include a CF Valve.

In another embodiment, a movement system includes: a cartridge with a cartridge inlet area and a cartridge outlet area; a housing with a housing inlet area and a housing outlet area; wherein the cartridge transfers at least one or more gases and one or more liquids from the housing inlet area to the housing outlet area independent of a relative position of the cartridge inlet area to the housing inlet area and the cartridge outlet area to the housing outlet area. In addition, the cartridge may include a body with a first groove, a body inlet area, and a body outlet area. In addition, the cartridge may include an o-ring coupled to body via the first groove. Further, the cartridge may include a throttle pin coupled to the inlet area. In addition, the cartridge may include a spring cap with a groove area, a spring cap inlet area, a spring cap outlet area, and a spring cap o-ring coupled to the spring cap via the groove area. Further, the cartridge may include a spring coupled to a bottom retainer. Further, the cartridge may include a diaphragm coupled to the bottom retainer. In addition, the cartridge may include a top retainer coupled to the diaphragm. In addition, the cartridge may include a CF Valve.

In another embodiment, a cartridge includes: a body with a first groove and a second groove, the body including a body inlet area and a body outlet area; an o-ring coupled to body via the first groove; a throttle pin including a pin and a pinhead coupled to the inlet area; a spring cap with a groove area, a spring cap inlet area, and a spring cap outlet area; a spring cap o-ring coupled to the spring cap via the groove area; a spring coupled to a bottom retainer; a diaphragm coupled to the bottom retainer; and a top retainer coupled to the diaphragm. In addition, the at least one of the pin and the pinhead may have a ratio of greater than 1 to the body. Further, the at least one of the pin and the pinhead may have a ratio of less than 1 to the body. In addition, the cartridge may be configured to be inserted into a device. Further, the cartridge may be configured to be inserted into an existing device where the existing device has one or more inlet ports and outlet ports in any locations on the existing device.

In one embodiment, a cartridge may include: a body with a first groove and a second groove, the body including a body inlet area and a body outlet area; an o-ring coupled to body via the first groove; a throttle pin coupled to a top retainer through the inlet area; a spring cap with a groove area; a spring cap o-ring coupled to the spring cap via the groove area; a spring coupled to a bottom retainer; a diaphragm coupled to the bottom retainer; and the top retainer coupled to the diaphragm.

In addition, the cartridge may be inserted into a manifold of a bar gun system. Further, the bar gun system may include one or more solenoids located inside a bar gun; the manifold; the bar gun system, and/or any other element disclosed in this disclosure. In addition, a cartridge inlet area and a cartridge outlet area may be in series with each other. Further, a cartridge inlet area and a cartridge outlet area may be at a 90 degree angle to each other. Further, the body may include a 360 degree outlet passage. In addition, the spring cap may create a seal by compressing the diaphragm to the body.

In another embodiment, a valve may include: an inlet mount coupled to a first assembly O-ring and a second assembly O-ring; a first throttle pin coupled to the inlet mount and a body; a second throttle pin coupled to the inlet mount and the body; a first diaphragm assembly coupled to the body and a first spring; a second diaphragm assembly coupled to the body and a second spring; a spring cup coupled to the first spring, the second spring, and the body; and the body coupled to the inlet mount.

In addition, the inlet mount may be coupled to the first assembly O-ring at a first inlet mount location and the second assembly O-ring may be coupled to the inlet mount at a second inlet mount location. Further, the first assembly O-ring may be a first size and the second assembly O-ring may be a second size. In addition, the first throttle pin may be coupled to the inlet mount at a first inlet mount throttle pin location and the first throttle pin may be coupled to the body at a first throttle pin body location and the second throttle pin may be coupled to the inlet mount at a second inlet mount throttle pin location and the second throttle pins may be coupled to the body at a second throttle pin body location. In addition, the first throttle pin may be a first size and the second throttle pin may be a second size. In addition, the first diaphragm assembly may be coupled to the body at a first diaphragm assembly body location and the second diaphragm assembly may be coupled to the body at a second diaphragm assembly body location. Further, the first diaphragm assembly may be a first size and the second diaphragm assembly may be a second size. Further, the first spring may be a first size and the second spring may be a second size.

In another embodiment, a bar gun device may include: a manifold; a first tube; a second tube; an Nth tube; a first CF Valve located at a first position inside the first tube; a second CF valve located at a second position inside the second tube; an Nth CF valve located at an Nth position inside of the Nth tube; and a bar gun.

In addition, the first location may be a different position than the second location or the third location. Further, the bar gun device may include a first solenoid before the first CF valve, a second solenoid before the second CF valve, and an Nth solenoid before the Nth CF valve. In addition, the bar gun device may include a communication device which communicates between the bar gun and at least one of the first solenoid, the second solenoid, and the Nth solenoid. In addition, the communication device may actuate one or more of the first solenoid, the second solenoid, and the Nth solenoid.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. Any combination of any element in this disclosure with any other element in this disclosure is hereby disclosed.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. A cartridge comprising:
a body with a first groove and a second groove, the body including a body inlet area and a body outlet area;
an o-ring coupled to body via the first groove;
a throttle pin coupled to a top retainer through the inlet area;
a spring cap with a groove area;
a spring cap o-ring coupled to the spring cap via the groove area;
a spring coupled to a bottom retainer;
a diaphragm coupled to the bottom retainer; and
the top retainer coupled to the diaphragm.

2. The cartridge of claim 1, wherein the cartridge is configured to be inserted into a manifold of a bar gun system.

3. The cartridge of claim 2, wherein the bar gun system includes one or more solenoids located inside at least one of a bar gun; the manifold; and the bar gun system.

4. The cartridge of claim 1, wherein a cartridge inlet area and a cartridge outlet area are in series with each other.

5. The cartridge of claim 1, wherein a cartridge inlet area and a cartridge outlet area are at a 90 degree angle to each other.

6. The cartridge of claim 1, wherein the body includes a 360 degree outlet passage.

7. The cartridge of claim 1, wherein the spring cap is configured to create a seal by compressing the diaphragm to the body.

8. A valve comprising:
an inlet mount coupled to a first assembly O-ring and a second assembly O-ring;
a first throttle pin coupled to the inlet mount and a body;
a second throttle pin coupled to the inlet mount and the body;
a first diaphragm assembly coupled to the body and a first spring;
a second diaphragm assembly coupled to the body and a second spring;
a spring cup coupled to the first spring, the second spring, and the body;
and the body coupled to the inlet mount.

9. The valve of claim 8, wherein the inlet mount is coupled to the first assembly O-ring at a first inlet mount location and the second assembly O-ring is coupled to the inlet mount at a second inlet mount location.

10. The valve of claim 8, wherein the first assembly O-ring is a first size and the second assembly O-ring is a second size.

11. The valve of claim 8, wherein the first throttle pin is coupled to the inlet mount at a first inlet mount throttle pin location and the first throttle pin is coupled to the body at a first throttle pin body location and the second throttle pin is coupled to the inlet mount at a second inlet mount throttle pin location and the second throttle pins is coupled to the body at a second throttle pin body location.

12. The valve of claim 11, wherein the first throttle pin is a first size and the second throttle pin is a second size.

13. The valve of claim 8, wherein the first diaphragm assembly is coupled to the body at a first diaphragm assembly body location and the second diaphragm assembly is coupled to the body at a second diaphragm assembly body location.

14. The valve of claim 13, wherein the first diaphragm assembly is a first size and the second diaphragm assembly is a second size.

15. The valve of claim 8, wherein the first spring is a first size and the second spring is a second size.

16. A bar gun device comprising:
a manifold;
a first tube;
a second tube;
an Nth tube;
a first CF Valve located at a first position inside the first tube;
a second CF valve located at a second position inside the second tube;
an Nth CF valve located at an Nth position inside of the Nth tube; and
a bar gun.

17. The bar gun device of claim 16, wherein the first location is a different position than the second location or the third location.

18. The bar gun device of claim 16, further comprising a first solenoid before the first CF valve, a second solenoid before the second CF valve, and an Nth solenoid before the Nth CF valve.

19. The bar gun device of claim 18, further comprising a communication device which communicates between the bar gun and at least one of the first solenoid, the second solenoid, and the Nth solenoid.

20. The bar gun device of claim 19, wherein the communication device actuates one or more of the first solenoid, the second solenoid, and the Nth solenoid.
